(19) United States
(12) Patent Application Publication
(10) Pub. No.: US 2006/0072152 A1
(43) Pub. Date: Apr. 6, 2006

(54) Printing system for dedicatedly storing a printing image

(75) Inventors: Oleksandr Krykun, Suwon-si (KR); Alexei Zavitaev, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/238,066

(22) Filed: Sep. 29, 2005

(30) Foreign Application Priority Data
Oct. 6, 2004 (KR) 2004-79472

(51) Int. Cl. G06F 3/12

(52) U.S. Cl. 358/1.15

(57) ABSTRACT

A printing system which dedicatedly stores a printing image, and a method for using the same. The printing system comprises a printer server for storing a plurality of images and connecting to a network, and an image forming apparatus for receiving a print job comprising an image from a information processor connected to the network, requesting the printer server search for the image and upon transmission of the requested image, printing out the image. Accordingly, resources required for image processing can be saved. In addition, printing speed can be enhanced by receiving and directly printing out the dedicatedly stored image.

### CROSS-REFERENCE TO RELATED APPLICATIONS

This application claims the benefit under 35 U.S.C. § 119(a) of Korean Patent Application No. 2004-79472, filed Oct. 6, 2004, the entire contents of which are hereby incorporated by reference.

### BACKGROUND OF THE INVENTION

1. Field of the Invention

The present invention relates to a printing system and method for dedicatedly storing a printing image. More particularly, the present invention relates to a printing system and method for dedicatedly storing a printing image and preparing for repetitive printing of the same image.

2. Description of the Related Art

General image forming apparatuses such as a printer and multifunction office machine transceive data with a data processor such as a computer through a serial or a parallel line and receive printing data from the data processor to print out the printing data onto paper.

In order to print out data including an image, an application program is loaded on the computer, printing data is generated, and a printing job including the printing data is transmitted to an image forming apparatus using languages such as printer control language (PCL) and postscript. When an image is included in the printing job, the image is transmitted to the image forming apparatus in various formats such as bitmap or red-green-blue (RGB).

The image forming apparatus converts the data of the various formats to the bitmap data which is interpretable by a printer engine, according to the transmitted printing job. Then, the bitmap data is printed onto paper, being passed through image processing such as half-toning for image enhancement.

Since most of the image forming apparatuses have a limited memory, the printing data needs to be removed from the memory after being printed on the printing paper, so that another printing job transmitted from the computer can be processed.

Therefore, when a user intends to print the used image according to a new printing job including the same image as the used image, the processes of image transmission, image processing and image printing needs to be repeated.

In an environment such as an office, where a plurality of users process jobs using computers and print out data using image forming apparatuses, the plurality of apparatuses and computers are connected through networks for efficiency.

In the above environment, repetitive transmission of printing jobs including the same image such as a company logo to the image forming apparatus may often be required.

In this case, the user makes data by loading a document having the image on his/her computer and transmits the printing job to the image forming apparatus through the network. Accordingly, printing data is image processed and printed out onto paper.

Therefore, the image forming apparatus has to repeat data reception and image processing whenever a request for the printing job is received, thereby causing inefficient use of resources of the image forming apparatus.

Furthermore, in such an environment where the plurality of users repetitively print the same image through the plurality of image forming apparatuses, it results in inefficient use of memory.

### SUMMARY OF THE INVENTION

An aspect of the present invention is to solve at least the above problems and/or disadvantages and to provide at least the advantages described below. Accordingly, an aspect of the present invention is to provide a printing system which stores a printing image processed for repetitive use in a dedicated server and prints the printing image by searching for the required image upon request for the print job, and a method for using the same.

In order to achieve the above-described aspects of the present invention, there is provided a printing system which dedicatedly stores a printing image. The printing system comprises a printer server for storing a plurality of images and connecting to a network; and an image forming apparatus for receiving a print job comprising an image from an information processor connected to the network, requesting the printer server to search for the image and upon transmission of the requested image, printing out the image.

The plurality of images are stored in the printer server and processed for printing.

The image forming apparatus preferably transmits an identification (ID) for recognition of the image to the printer server when requesting the image search.

The image ID is calculated by the image forming apparatus as the checksum, such as CRC32, CRC64 or similar of the original (not processed) image data.

The printer server preferably dedicatedly stores an index table comprising a list in which the image IDs and stored locations of the images are matched.

The printer server preferably searches for the image ID from the index table and reads out the image according to the stored location.

The image forming apparatus preferably transmits to the printer server information for checking whether the read image corresponds to the requested image. The printer server checks whether the stored image corresponds to the requested image according to the image information.

When no corresponding image is stored as a result of the image search, the printing server informs the image forming apparatus of the absence of the requested image.

Upon being informed of the absence, the image forming apparatus performs the image processing for printing with the image and prints out the image, and transmits the processed image and the image ID for recognition of the image to the printer server.

The printer server stores the image by matching the image ID and the stored location, respectively, so that a desired image can be easily searched for using the image ID.

A printing method for dedicatedly storing a printing image according to another aspect of the present invention comprises the steps of receiving a printing job from an information processor connected to network according to a printing command; when the printing job comprises an image, requesting the printer server storing a plurality of images and connected to the network search for the image; searching for the image and when the requested image exists, transmitting the image to the image forming apparatus; and printing the received image.

### BRIEF DESCRIPTION OF THE DRAWINGS

The above aspect and other features of the present invention will become more apparent by describing in detail exemplary embodiments thereof with reference to the accompanying drawing figures, wherein;

FIGS. 1A and 1B show an exemplary environment for applying a printing system which dedicatedly stores a printing image according to an embodiment of the present invention;

FIG. 2 is a block diagram illustrating the printing system for dedicatedly storing the printing image according to an embodiment of the present invention; and

FIG. 3 is a flowchart for explaining the operation of the printing system according to an embodiment of the present invention.

Throughout the drawings, the same or similar elements, features and structures are represented by the same reference numerals.

### DETAILED DESCRIPTION OF EXEMPLARY EMBODIMENTS

Hereinafter, exemplary embodiments of the present invention will be described in detail with reference to the accompanying figures.

The matters defined in the description such as a detailed construction and elements are exemplary and it should be apparent that the present invention performed without the specific examples. Also, well-known functions or constructions are not described in detail for conciseness.

Hereinbelow, a printer will be described as an example of an image forming apparatus for convenient explanation although embodiments of the present invention are not limited thereto.

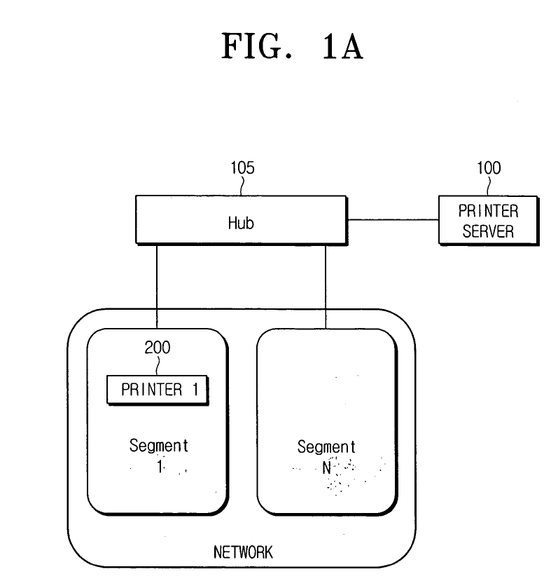

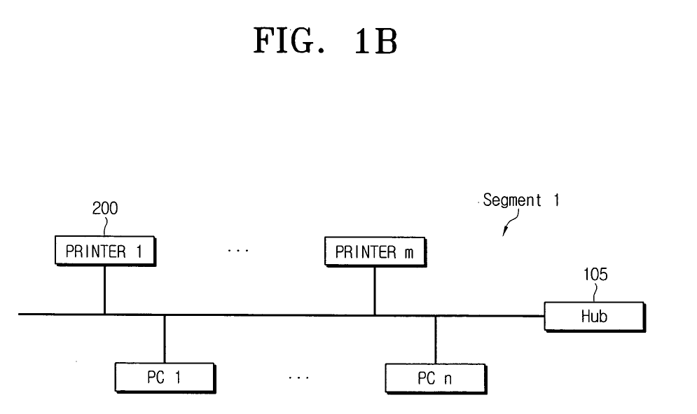

Referring to FIG. 1A, a printer server 100 is connected to a network through a hub 105. The network comprises a plurality of segments 1 to N respectively comprising a plurality of computers and at least one image forming apparatus. The segment refers to a kind of sub network physically or theoretically divided, such as one floor or a department in a building.

FIG. 1B illustrates a segment 1 in which a plurality of printers comprising a printer 200 and a plurality of personal computers PC1 to PCn are interconnected through a communication channel such as a wireless local area network (WLAN) to thereby form a network, and connected to a printer server through the hub 105.

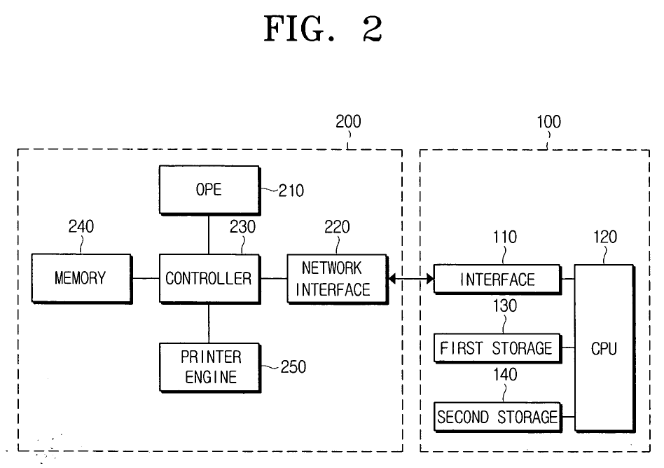

FIG. 2 is a block diagram illustrating a printing system for dedicatedly storing a printing image, according to an embodiment of the present invention.

Referring to FIG. 2, the printing system comprises the printer and the printer server.

The printer 200 constituting the printing system according to an exemplary embodiment of the present invention, comprises an operation panel (OPE) 210, a network interface 220, a controller 230, a memory 240 and a printer engine 250.

The OPE 210 is equipped with a plurality of numerical keys and function keys for controlling the printer and a liquid crystal display (LCD) for showing the operational state or status of the printer. The OPE 210 applies control signals generated by the key operation to the controller 230.

The network interface 220 receives data applied from a device connected to the network and the printer server and transmits data transmitted by the printer 200 to the network and the printer server by interfacing between the device connected to the network and the printer server and the controller 230.

The controller 230 regulates the overall operation of the printer 200. For example, upon transmission of the print job from the computer connected to the network, the controller 230 communicates with the printer server 100 to determine whether the printer server 100 has a halftone image which is the final image to be printed out by the printer engine 250, generated by performing image enhancement processing such as edge enhancement and smoothing with respect to the image that includes the print job. If the halftone image exists in the printer server 100, the controller 230 temporarily stores the halftone image in the memory 240 or transmits the halftone image to the printer engine 250 for printing the from the printer server 100. When the controller 230 communicates with the printer server 100, the images can be recognized using image ID. The image ID is unique for each image. Any printer in the network should be able to generate same unique ID for same image, based only on the image itself. For example, checksum calculating methods such as commonly used CRC 32 and CRC 64 may be applied for an ID generation method.

When the halftone image does not exist in the printer server 100, the controller 230 converts the corresponding image to a bitmap form and generates the halftone image by performing the image enhancement processes. Then, the controller 230 temporarily stores the halftone image in the memory 240 or transmits the halftone image to the printer engine 250 for printing.

The memory 240 comprises a non-volatile memory for storing various control programs for operating the printer 200 and a volatile memory for storing data generated during the operation of the printer 200 and detailed information on the data. For example, the volatile memory temporarily stores various data such as the printing data and the halftone image received from the computer or the printer server 100 through the network interface 220. Also, the non-volatile memory stores various information required for data communication with the computer and the printer server and information on a protocol.

The printer engine 250 prints out the printing data comprising the halftone image processed for printing, the printing data processed by the controller 230 and stored in the memory 240. Otherwise, the printer engine 250 may print out a printing page generated by the controller 230 by arranging the images received from external devices such as the printer server 100 according to a print page layout.

The printer server 100 comprises an interface 110, a CPU 120, a first storage 130 and a second storage 140.

The interface 110 receives data applied from the respective printers or transmits the data transmitted from the printer server 100 to the corresponding printers by interfacing through the hub 105 between the plurality of printers included in the plurality of segments constituting the network and the CPU 120.

The CPU 120 controls the overall operation of the printer server 100. For example, upon receiving from the printer 200 an image search requesting message comprising the image ID and the information on the image, the CPU 120 searches the image ID included in the requesting message from the first storage 130 and determines whether the image ID exists in the first storage 130. When the requested image ID exists, the CPU 120 reads out from the second storage 140 the image corresponding to the image ID and compares the information on the read image with the image information included in the requesting message. If the read image corresponds to the requested image as a result of the comparison, the CPU 120 transmits the read image to the printer 200.

The first storage 130 stores an index table in which a storing location and the ID of the image stored in the second storage 140 are matched and listed. Accordingly, the CPU 120 searches the index table for the corresponding ID and information according to the image ID and information included in the image search requesting message transmitted from the printer 200.

The second storage 140 stores the plurality of image and the information on the image together, and the first storage 130 stores the image storing locations together with the image IDs as the index table. Therefore, the image stored in the second storage 140 can be easily found by searching the index table stored in the first storage 130 using the image ID. Here, the image stored in the second storage 140 is the halftone image converted to the bitmap form for direct printing by the printer engine 250, passed through the image enhancement processes such as halftoning and edge enhancement and finally printed out.

When the capacity of the second storage 140 is full, in order to reserve the storing capacity, the images may be removed in order of the time they were stored, thereby removing most previously stored images and saving recently stored images, or removed in order of accessed time, thereby removing images which have not been accessed for a long time and saving recently accessed images.

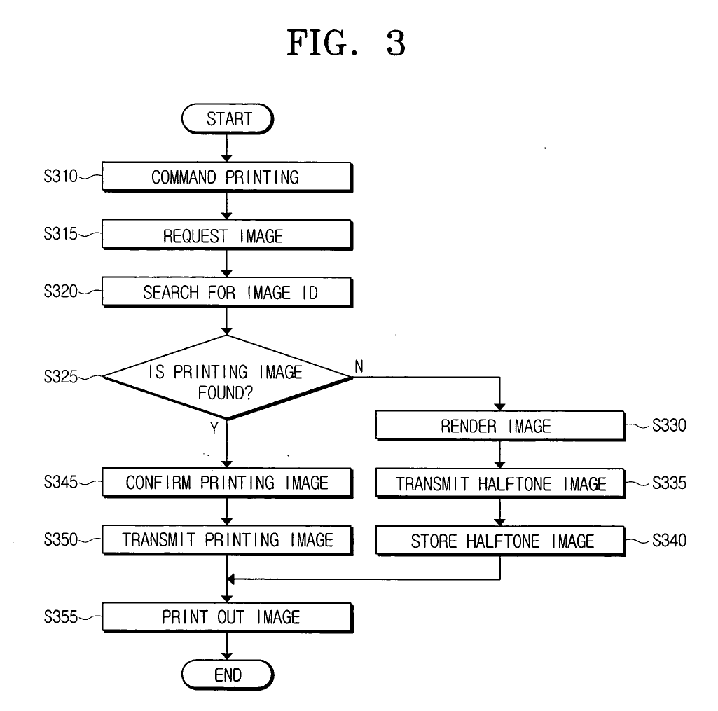

FIG. 3 is a flowchart illustrating the operation of the printing system according to an exemplary embodiment of the present invention.

When a printing command comprising the printing data is received at the printer 200 from the computer connected to the network at step S310, the controller 230 interprets the printing data and when the printing data comprises an image, transmits the image search requesting message comprising the information such as the ID and the size of the image at step S315.

The CPU 120 of the printer server 100 searches the index table stored in the first storage 130 to look up a matching image ID as included in the requesting message at step S320.

If no matching image ID is found at step S325, the printer server 100 informs the printer 200 of the absence of the requested image. Accordingly, the controller 230 of the printer 200 converts the image of the printing data to the bitmap image and renders the image through the image enhancement processing such as the halftoning, thereby generating the halftone image at step S330.

The controller 230 transmits the halftone image together with the image ID and the image information to the printer server 100 at step S335 so that the image is stored in the second storage 140 and the stored location and the ID are stored in the first storage 130 as explained above at step S340.

When a matching image ID as included in the requesting message is found, the CPU 120 reads out the stored location of the corresponding image from the index table. According to the stored location as read out, the CPU 120 reads out the corresponding image and the image information stored in the second storage 140 and compares the read image information with the image information as included in the requesting message to check whether the read image corresponds to the requested image at step S345.

When the read image corresponds to the requested image, the printer server 100 transmits the read halftone image to the printer 200 at step S350. The controller 230 of the printer 200 controls the printer engine 250 to print the transmitted halftone image at step S355.

As described above, according to an embodiment of the present invention, since the halftone image processed to be directly printed by the printer engine 250 for repetitive printing is dedicatedly stored at the printer server 100, resources required for image processing in the image forming apparatus can be efficiently used.

In addition, the printing speed can be improved because the image forming apparatus can immediately print out the dedicatedly stored halftone image as soon as the halftone image is received.

While the invention has been shown and described with reference to certain embodiments thereof, it will be understood by those skilled in the art that various changes in form and details may be made therein without departing from the spirit and scope of the invention as defined by the appended claims.

What is claimed is:

1. A printing system which dedicatedly stores a printing image, the printing system comprising:
a printer server for storing a plurality of printing images and connecting to a network; and
an image forming apparatus for receiving a printing job comprising an image from an information processor connected to the network, requesting the printer server search for a printing image corresponding to the image and printing out the printing image upon transmission of the requested printing image.

2. The printing system of claim 1, wherein the plurality of printing images are stored in the printer server processed and ready for printing.

3. The printing system of claim 1, wherein the image forming apparatus transmits an identification (ID) for recognition of the image to the printer server when requesting the image search.

4. The printing system of claim 3, wherein the image ID is calculated by the image forming apparatus as the checksum, such as CRC32, CRC64 or similar of the original image data.

5. The printing system of claim 3, wherein the printer server dedicatedly stores an index table comprising a list in which the image IDs and stored locations of the images are matched.

6. The printing system of claim 5, wherein the printer server searches for the image ID from the index table and reads out the printing image according to the stored location.

7. The printing system of claim 1, wherein the image forming apparatus transmits to the printer server information for determining whether the read printing image corresponds to the requested image.

8. The printing system of claim 7, wherein the printer server checks whether the stored printing image corresponds to the requested image according to the image information.

9. The printing system of claim 1, wherein, when no corresponding printing image is stored as a result of the image search, the printing server informs the image forming apparatus of an absence of the requested image.

10. The printing system of claim 9, wherein, upon being informed of the absence, the image forming apparatus performs the image processing for printing with the image and prints out the processed image, and transmits the processed image and the image ID for recognition of the image to the printer server.

11. The printing system of claim 10, wherein the printer server stores the processed image as the printing image by matching the image ID and the stored location, respectively, so that a desired printing image can be easily searched for using the image ID.

12. A printing method for dedicatedly storing a printing image, the method comprising the steps of:
receiving a printing job from an information processor connected to network according to a printing command;
requesting a printer server storing a plurality of images and connected to the network search for the image;
searching for the image and when the printing job comprises an image, transmitting the image to an image forming apparatus; and
printing the received image.

13. The method of claim 12, wherein the plurality of images are stored in the printer server and image processed for printing.

14. The method of claim 12, wherein the step of requesting step comprises:
transmitting an identification (ID) for recognition of the image to the printer server.

15. The method of claim 14, wherein the printer server dedicatedly stores an index table comprising a list in which the image IDs and stored locations of the images are matched.

16. The method of claim 15, wherein, the step of transmitting comprises:
searching for the image ID from the index table and reading out the image according to the stored location.

17. The method of claim 12, wherein, the step of requesting comprises:
transmitting information for checking whether the read image corresponds to the requested image.

18. The method of claim 17, wherein the printer server determines whether the stored image corresponds to the requested image according to the image information.

19. The method of claim 12, further comprising the step of:
informing the image forming apparatus of absence of the requested image when no corresponding image is stored as a result of the image search.

20. The method of claim 19, further comprising the step of:
performing the image processing for printing with the image and transmitting the processed image and the image ID for recognition of the image to the printer server upon being informed of the absence.

21. The method of claim 20, further comprising the step of:
storing the image by matching the image ID and the stored location, respectively, so that a desired image can be easily searched for using the image ID.
